(19) United States
(12) Patent Application Publication
(10) Pub. No.: US 2024/0182032 A1
(43) Pub. Date: Jun. 6, 2024

(54) VEHICLE CONTROL DEVICE, CONTROL METHOD, AND NON-TRANSITORY STORAGE MEDIUM

(71) Applicant: TOYOTA JIDOSHA KABUSHIKI KAISHA, Aichi-ken (JP)

(72) Inventors: Yusuke Ouchi, Numazu-shi, Shizuoka-ken (JP); Toshinori Okita, Gotemba-shi, Shizuoka-ken (JP); Tomohiko Inoue, Kariya-city, Aichi-pref (JP); Youhei Masui, Kariya-city, Aichi-pref (JP)

(21) Appl. No.: 18/284,178

(22) PCT Filed: Mar. 18, 2022
(86) PCT No.: PCT/IB2022/000139

§ 371 Date: Sep. 26, 2023

(30) Foreign Application Priority Data
Mar. 29, 2021 (JP) 2021-055516

(51) Int. Cl. B60W 30/16; B60W 30/14

(52) U.S. Cl. CPC B60W 30/162; B60W 30/146; B60W 2540/10; B60W 2554/80; B60W 2555/00

(57) ABSTRACT

A control device (100) executes control for accelerating or decelerating a vehicle (1) such that constant-speed travel in which the vehicle (1) travels at a set vehicle speed is performed, and such that following travel in which the vehicle follows a preceding vehicle ahead is performed. The control device includes a processor (120) configured to: acquire drive environment information indicating a drive environment of the vehicle; perform acceleration suppression for suppressing acceleration of the vehicle for the constant-speed travel or the following travel when the drive environment is a predetermined situation; establish an acceleration suppression stop state in which the acceleration suppression is temporarily stopped when an operation to turn on an accelerator of the vehicle has been performed; and cancel the acceleration suppression stop state based on a predetermined resumption condition for resuming the acceleration suppression when or after an operation to turn off the accelerator of the vehicle has been performed.

### BACKGROUND OF THE INVENTION

### 1. Field of the Invention

The present disclosure relates to a control device, a control method, and a non-transitory storage medium configured to execute control for accelerating or decelerating a vehicle such that constant-speed travel or following travel is performed.

### 2. Description of Related Art

Japanese Unexamined Patent Application Publication No. 2009-107451 (JP 2009-107451 A) discloses a vehicle travel control device that can reduce an uncomfortable feeling given to a driver when a travel environment acquisition unit determines that the vehicle is exiting from a main road during travel on the main road. The vehicle travel control device suppresses acceleration of the vehicle when a travel environment acquired by the travel environment acquisition unit is not suitable for acceleration. On the other hand, the vehicle travel control device cancels the suppression of acceleration when an intention to accelerate is acquired from the driver.

### SUMMARY OF THE INVENTION

In so-called adaptive cruise control (ACC) for accelerating or decelerating a vehicle such that constant-speed travel in which the vehicle travels at a set vehicle speed or following travel in which the vehicle travels following a preceding vehicle ahead is performed, it is considered to perform acceleration suppression, in which acceleration of the vehicle is suppressed under the ACC, when the drive environment of the vehicle is a predetermined situation.

While the driver is performing an operation to turn on an accelerator of the vehicle, on the other hand, the driver is considered to have an intention to accelerate the vehicle, and it is considered to temporarily stop the acceleration suppression. It is necessary to appropriately define a condition for canceling the temporary stop of the acceleration suppression. If the condition is only that an operation to turn off the accelerator is performed, however, the acceleration suppression may be unnecessarily performed against the intention of the driver, and the comfort of the driver may be impaired.

The present invention proposes a control device, a control method, and a non-transitory storage medium that can perform acceleration suppression in ACC in appropriate situations.

A first aspect of the present disclosure provides a control device configured to execute control for accelerating or decelerating a vehicle such that constant-speed travel in which the vehicle travels at a set vehicle speed is performed, and configured to execute control for accelerating or decelerating the vehicle such that following travel in which the vehicle follows a preceding vehicle ahead is performed. The control device includes a processor. The processor is configured to: acquire drive environment information that indicates a drive environment of the vehicle; perform acceleration suppression for suppressing acceleration of the vehicle for the constant-speed travel or the following travel when the drive environment is a predetermined situation; establish an acceleration suppression stop state in which the acceleration suppression is temporarily stopped when an operation to turn on an accelerator of the vehicle has been performed; and execute a cancellation process of canceling the acceleration suppression stop state based on a predetermined resumption condition for resuming the acceleration suppression when or after an operation to turn off the accelerator of the vehicle has been performed.

In the first aspect, the predetermined resumption condition may be met in the cancellation process when one of the following conditions is met: a vehicle speed of the vehicle is a predetermined proportion or more of the set vehicle speed; the following travel is being performed; the drive environment is brought into a new predetermined situation in which acceleration suppression is to be performed; and control for decelerating the vehicle is performed for the constant-speed travel or the following travel.

A second aspect of the present disclosure provides a control method. The control method accelerates or decelerates a vehicle such that constant-speed travel in which the vehicle travels at a set vehicle speed is performed, and accelerates or decelerates the vehicle such that following travel in which the vehicle follows a preceding vehicle ahead is performed. The control method includes, by a processor: acquiring drive environment information that indicates a drive environment of the vehicle; performing acceleration suppression for suppressing acceleration of the vehicle for the constant-speed travel or the following travel when the drive environment is a predetermined situation; establishing an acceleration suppression stop state in which the acceleration suppression is temporarily stopped when an operation to turn on an accelerator of the vehicle has been performed; and executing a cancellation process of canceling the acceleration suppression stop state based a predetermined resumption condition for resuming the acceleration suppression when or after an operation to turn off the accelerator of the vehicle has been performed.

In the second aspect, the predetermined resumption condition may be met in the cancellation process when one of the following conditions is met: a vehicle speed of the vehicle is a predetermined proportion or more of the set vehicle speed; the following travel is being performed; the drive environment is brought into a new predetermined situation in which acceleration suppression is to be performed; and control for decelerating the vehicle is performed for the constant-speed travel or the following travel.

A third aspect of the present disclosure provides a non-transitory storage medium storing instructions that are executable by one or more processors of a computer, and that cause the one or more processors to execute the following functions. The functions include: acquiring drive environment information that indicates a drive environment of the vehicle; performing acceleration suppression for suppressing acceleration of the vehicle for the constant-speed travel or the following travel when the drive environment is a predetermined situation; executing an acceleration suppression stop state in which the acceleration suppression is temporarily stopped when an operation to turn on an accelerator of the vehicle has been performed; and executing a cancellation process of canceling the acceleration suppression stop state based on a predetermined resumption condition for resuming the acceleration suppression when or after an operation to turn off the accelerator of the vehicle has been performed.

In the third aspect, the predetermined resumption condition may be met in the cancellation process when one of the following conditions is met: a vehicle speed of the vehicle is a predetermined proportion or more of the set vehicle speed; the following travel is being performed; the drive environment is brought into a new predetermined situation; and control for decelerating the vehicle is performed for the constant-speed travel or the following travel.

According to the first aspect, the second aspect, and the third aspect of the present disclosure, the acceleration suppression stop state in which acceleration suppression is temporarily stopped can be continued, even if an operation to turn off the accelerator of the vehicle is performed, until the predetermined resumption condition is met while the acceleration suppression stop state is established when an operation to turn on the accelerator is performed. Consequently, it is possible to reduce the possibility that acceleration suppression is performed unnecessarily, and to perform acceleration suppression in the ACC in appropriate situations.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a conceptual diagram illustrating an overview of acceleration suppression;

FIG. 2 is a conceptual diagram illustrating an overview of an acceleration suppression stop state;

FIG. 3 is a conceptual diagram illustrating an overview of a control method by a control device according to the present embodiment;

FIG. 4 is a block diagram illustrating the configuration of a vehicle system according to the present embodiment;

FIG. 5 is a block diagram illustrating the flow of a process executed by the control device according to the present embodiment;

FIG. 6 is a flowchart illustrating a process for an ACC control processing section illustrated in FIG. 5 to determine whether to perform acceleration suppression;

FIG. 7 is a flowchart illustrating a process executed by a temporary stop determination processing section illustrated in FIG. 5; and

FIG. 8 is a flowchart illustrating a process executed in a temporary stop flag cancellation process illustrated in FIG. 7.

### DETAILED DESCRIPTION OF EMBODIMENTS

An embodiment of the present invention will be described below with reference to the drawings. When the number, quantity, amount, range, etc. of elements are referred to in the embodiment described below, the idea of the present disclosure is not limited to such numbers unless specifically stated otherwise or such numbers are clearly specified in principle. In addition, components etc. described in relation to the embodiment described below are not necessarily essential to the idea of the present disclosure unless specifically stated otherwise or such components are clearly specified in principle. Like or corresponding portions are denoted by like signs in the drawings so that redundant description of such portions will be simplified or omitted as appropriate.

### 1. Overview

A control device according to the present embodiment executes ACC for accelerating or decelerating a vehicle such that constant-speed travel is performed, in which the vehicle travels at a set vehicle speed, or following travel is performed, in which the vehicle travels following a preceding vehicle ahead. In addition, the control device according to the present embodiment performs acceleration suppression for suppressing acceleration of the vehicle in the ACC when the drive environment of the vehicle is a predetermined situation.

For example, acceleration suppression is performed in a situation in which the vehicle makes a right turn or a left turn at an intersection when the vehicle is traveling on a street, a situation in which the vehicle passes at a side of a pedestrian, a bicycle, a parked vehicle, etc., a situation in which the vehicle travels on a residential road, etc. The vehicle can travel appropriately through the ACC by performing acceleration suppression in situations in which it is considered to be unsuitable to accelerate significantly.

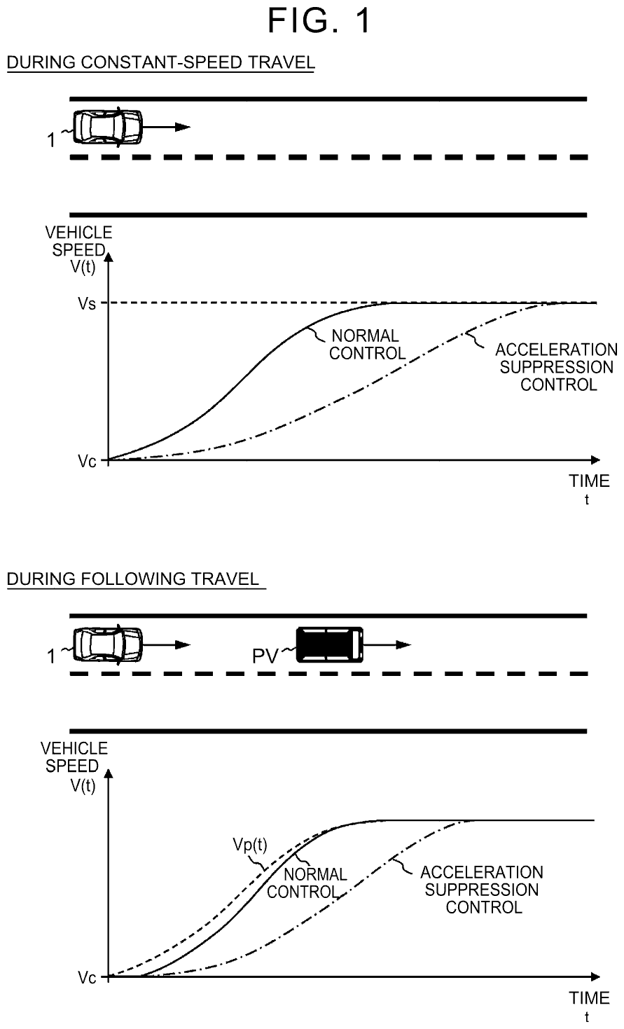

FIG. 1 is a conceptual diagram illustrating an overview of acceleration suppression. FIG. 1 illustrates comparison between variations V(t) (continuous line) in the vehicle speed of a vehicle 1 during normal control and variations V(t) (long dashed short dashed line) in the vehicle speed of the vehicle 1 during control (acceleration suppression control) in which acceleration suppression is performed, for each of the constant-speed travel and the following travel.

The upper part of FIG. 1 indicates the constant-speed travel, in which the vehicle 1 is controlled such that the vehicle speed is brought to a set vehicle speed Vs (dashed line). The lower part of FIG. 1 indicates the following travel, in which the vehicle 1 is controlled so as to follow a preceding vehicle PV. Vc represents the vehicle speed of the vehicle 1 at the time when the control is started. Vp(t) represents variations (dashed line) in the vehicle speed of the preceding vehicle PV.

When acceleration suppression is performed, as illustrated in FIG. 1, the vehicle speed of the vehicle 1 is varied to a target vehicle speed gently compared to the normal case.

It is typically determined based on information detected by a sensor provided in the vehicle 1 whether the drive environment of the vehicle 1 is a predetermined situation. On the other hand, it is assumed that the driver of the vehicle 1 desires to accelerate (hereinafter also referred to as “have an intention to accelerate”) the vehicle 1 without acceleration suppression being performed when acceleration suppression is performed excessively etc. because of erroneous detection by the sensor etc. Therefore, it is considered to establish an acceleration suppression stop state, in which acceleration suppression is temporarily stopped, while the driver is performing an operation to turn on the accelerator of the vehicle 1, the driver thereby being considered to have an intention to accelerate.

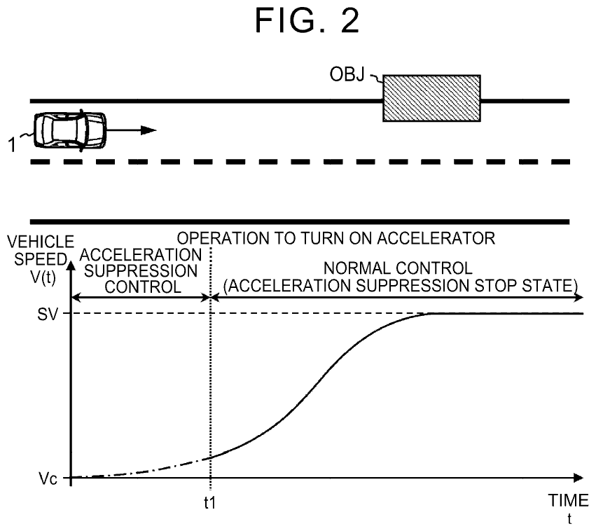

FIG. 2 is a conceptual diagram illustrating an overview of an acceleration suppression stop state. FIG. 2 illustrates a case where the vehicle 1 is controlled such that the vehicle speed is brought to the set vehicle speed Vs and it is determined that acceleration suppression is to be performed because of the presence of a target object OBJ around the vehicle 1. The driver does not perform an operation to turn on the accelerator of the vehicle 1 before time t1, and performs an operation to turn on the accelerator at and after time t1. FIG. 2 illustrates variations V(t) in the vehicle speed of the vehicle 1 in this case.

At this time, acceleration suppression control is performed before time t1. At and after time t1, on the other hand, an operation to turn on the accelerator is performed to temporarily stop acceleration suppression (acceleration suppression stop state), and the normal control is performed.

It is necessary to appropriately cancel the acceleration suppression stop state. It is conceivable to simply cancel the acceleration suppression stop state on condition that an operation to turn on the accelerator of the vehicle 1 by the driver is ended. With such a condition, however, acceleration suppression may be performed unnecessarily against the driver's intention to accelerate, since acceleration suppression is performed again in similar situations, for example. In addition, the comfort of the driver may be impaired, since the driver frequently performs an operation to turn on the accelerator in an attempt to establish the acceleration suppression stop state again, for example.

Thus, with the control device according to the present embodiment, the acceleration suppression stop state is established when the driver performs an operation to turn on the accelerator of the vehicle 1, and the acceleration suppression stop state is continued, even if an operation to turn off the accelerator is performed, until a predetermined resumption condition is met.

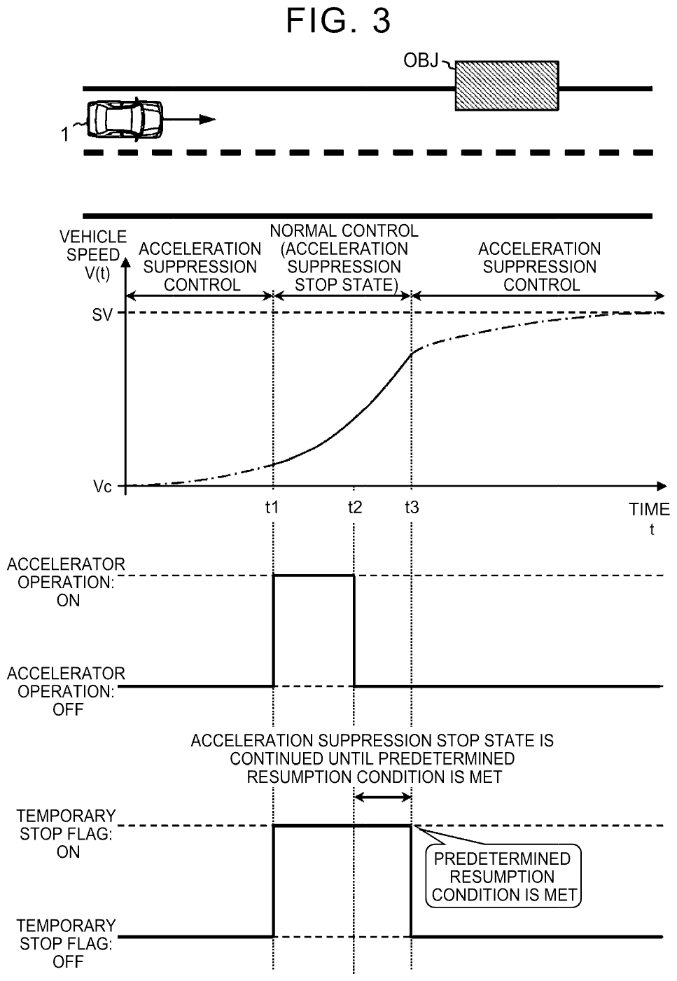

FIG. 3 is a conceptual diagram illustrating an overview of a control method by the control device according to the present embodiment. FIG. 3 illustrates a situation similar to that illustrated in FIG. 2, and illustrates a case where the vehicle 1 is controlled such that the vehicle speed is brought to the set vehicle speed Vs in a situation in which acceleration suppression is performed. FIG. 3 indicates variations V(t) in the vehicle speed of the vehicle 1 in this case, the state of an operation of the accelerator of the vehicle 1 by the driver, and the state of a temporary stop flag. The temporary stop flag is information provided as a result of a process executed by the control device, and indicates the acceleration suppression stop state when the temporary stop flag is turned on.

In FIG. 3, the driver performs an operation to turn on the accelerator of the vehicle 1 at time t1, and performs an operation to turn off the accelerator at time t2. At this time, the control device turns on the temporary stop flag at time t1 when an operation to turn on the accelerator is performed. On the other hand, the temporary stop flag is not turned off and the acceleration suppression stop state is continued, even after time t2 when an operation to turn off the accelerator is performed, before time t3 when a predetermined resumption condition is met.

With the control device according to the present embodiment, in this manner, the acceleration suppression stop state can be continued until a predetermined resumption condition that defines a case where it is considered to be suitable to perform acceleration suppression again etc. is met. Consequently, it is possible to reduce the possibility that acceleration suppression is performed unnecessarily, and to perform acceleration suppression in the ACC in appropriate situations. Hence, the comfort of the driver can be improved.

### 2. Configuration

The configuration of a vehicle system of the vehicle 1 according to the present embodiment will be described below.

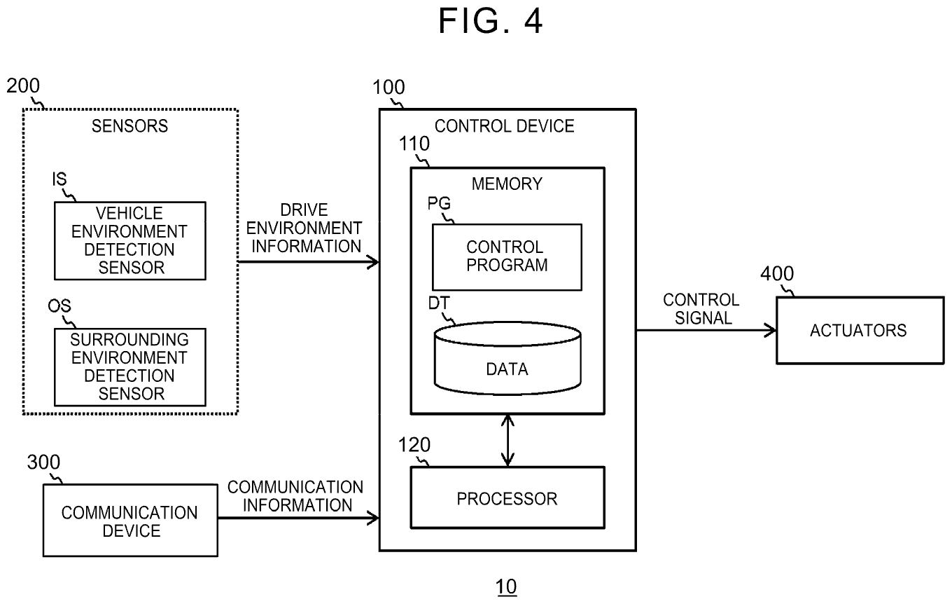

FIG. 4 is a block diagram illustrating the configuration of a vehicle system 10 of the vehicle 1 according to the present embodiment. The vehicle system 10 includes a control device 100, sensors 200, a communication device 300, and actuators 400. The control device 100 is configured to be able to communicate information with the sensors 200, the communication device 300, and the actuators 400. The devices are typically electrically connected to each other through a wire harness. However, the devices may be connected to each other by other methods. For example, the devices may be connected to each other wirelessly or via an optical communication line.

The sensors 200 detect and output information (drive environment information) that indicates the drive environment of the vehicle 1. The drive environment information detected by the sensors 200 is transferred to the control device 100. The sensors 200 include a vehicle environment detection sensor IS and a surrounding environment detection sensor OS.

The vehicle environment detection sensor IS detects information on the internal environment of the vehicle 1 such as the travel state (such as vehicle speed, acceleration, and yaw rate) of the vehicle 1. The vehicle environment detection sensor IS includes a sensor that detects the state of an operation of the accelerator of the vehicle 1. Examples of the vehicle environment detection sensor IS include an accelerator position sensor that detects the accelerator operation amount. Other examples of the vehicle environment detection sensor IS include a wheel speed sensor that detects the vehicle speed of the vehicle 1, an acceleration sensor that detects the acceleration of the vehicle 1, and an angular speed sensor that detects the yaw rate of the vehicle 1.

The surrounding environment detection sensor OS detects information on the external environment of the vehicle 1 such as the environment (such as preceding vehicles, lanes, and obstructions) around the vehicle 1. Examples of the surrounding environment detection sensor OS include a millimeter-wave radar, a sensor camera, and a light detection and ranging (LiDAR) sensor.

The drive environment information output from the sensors 200 may include not only information directly detected by the sensors, but also information obtained through computation processing from the directly detected information. For example, information on the type (such as pedestrian, sign, and column) of an object around the vehicle 1 obtained through computation processing from directly detected information on the shape, color, speed, etc. of the object may be output as the drive environment information. In this case, the computation processing may be executed by each of the sensors, or the sensors 200 may include a device that executes the computation processing.

The communication device 300 is a device that transmits and receives a variety of information (communication information) by communicating with a device that is external to the vehicle 1. The communication device 300 may be a device that performs inter-vehicle communication or road-vehicle communication, a global positioning system (GPS) receiver, a device connected to a communication network to communicate with a server on the communication network, etc. The communication information received by the communication device 300 is transferred to the control device 100. The communication information acquired by the control device 100 may include information that serves as the drive environment information for the vehicle 1. For example, the communication information may include the position of the vehicle 1 on a map, traffic information for a road on which the vehicle 1 travels, etc.

The control device 100 executes a variety of processes related to control of the vehicle 1 based on the acquired information, and generates and outputs a control signal. The control signal output from the control device 100 is transferred to the actuators 400. The control device 100 is typically provided in the vehicle 1. However, the control device 100 may be a device that is external to the vehicle 1. In this case, the control device 100 acquires information and outputs a control signal via communication with the vehicle 1.

The control device 100 is a computer that includes a memory 110 and a processor 120. The control device 100 is typically an electronic control unit (ECU). The memory 110 stores a control program PG that is executable by the processor, and data DT including information to be acquired by the control device 100 and a variety of information related to the control program PG. The memory 110 may store chronological data on the drive environment information for a certain period as the data DT. The processor 120 reads the control program PG from the memory 110, and executes a process according to the control program PG based on information in the data DT read from the memory 110.

The process executed by the control device 100, more particularly the process executed by the processor 120 in accordance with the control program PG, includes a process related to the ACC and a process related to acceleration suppression. These processes will be discussed in detail later.

The control device 100 may be a system constituted from a plurality of computers. In this case, the computers are configured to be able to communicate information with each other to such a degree that information necessary to execute the processes can be acquired. The control program PG may be a combination of a plurality of programs.

The actuators 400 operate in accordance with the control signal acquired from the control device 100. Examples of the actuators 400 include an actuator that drives an engine (such as an internal combustion engine, an electric motor, and a hybrid thereof), an actuator that drives a brake mechanism provided in the vehicle 1, and an actuator that drives a steering mechanism of the vehicle 1. A variety of control of the vehicle 1 by the control device 100 is implemented as the variety of actuators included in the actuators 400 operate in accordance with the control signal.

### 3. Process

The process executed by the control device 100 according to the present embodiment will be described below.

### 3-1. Flow of Process

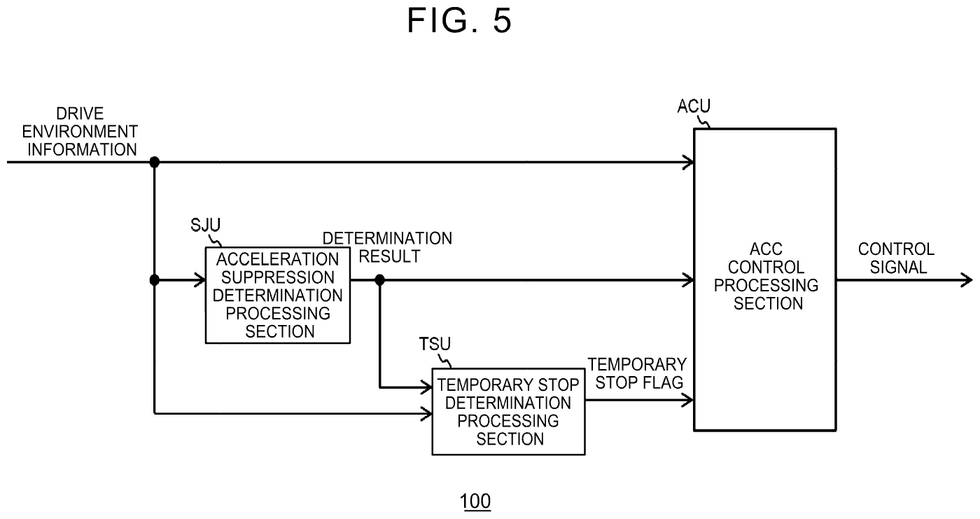

FIG. 5 is a block diagram illustrating the flow of the process executed by the control device 100. As illustrated in FIG. 5, the process executed by the control device 100 is constituted by an acceleration suppression determination processing section SJU, a temporary stop determination processing section TSU, and an ACC control processing section ACU. These may be constituted as a part of the control program PG, or may be constituted as a separate computer. The drive environment information illustrated in FIG. 5 may include not only the drive environment information acquired by the control device 100 from the sensors 200, but also information acquired as communication information.

The acceleration suppression determination processing section SJU determines, based on the drive environment information, whether the drive environment of the vehicle 1 is a predetermined situation in which acceleration suppression is to be performed (hereinafter also referred to simply as “predetermined situation”), and outputs the determination result. Examples of the predetermined situation include situations in which it is considered to be unsuitable to accelerate significantly, such as a situation in which the vehicle 1 makes a right turn or a left turn at an intersection when the vehicle is traveling on a street, a situation in which the vehicle passes at a side of a pedestrian, a bicycle, a parked vehicle, etc., a situation in which the vehicle travels on a residential road, etc. However, what situation is defined as the predetermined situation is not limited, and the predetermined situation may be defined optimally for the vehicle 1 to which the control device 100 is applied. Likewise, the determination method based on the drive environment information is also not limited.

When a plurality of predetermined situations are defined, the determination result indicating that the drive environment of the vehicle 1 is a predetermined situation may include information indicating which of the predetermined situations the drive environment of the vehicle 1 is.

The temporary stop determination processing section TSU determines, based on the drive environment information and the determination result acquired from the acceleration suppression determination processing section SJU, whether the vehicle is brought into the acceleration suppression stop state in which acceleration suppression is temporarily stopped, and outputs the temporary stop flag. The temporary stop determination processing section TSU turns on the temporary stop flag when determination is made that the vehicle is brought into the acceleration suppression stop state. The temporary stop flag is a Boolean value with 0 indicating off and 1 indicating on, for example. The process executed by the temporary stop determination processing section TSU will be discussed in detail later.

The ACC control processing section ACU executes the process related to the ACC based on the drive environment information, and generates and outputs a control signal for achieving the ACC. Further, the ACC control processing section ACU determines whether to perform acceleration suppression, based on the determination result acquired from the acceleration suppression determination processing section SJU and the temporary stop flag acquired from the temporary stop determination processing section TSU. When the ACC control processing section ACU determines to perform acceleration suppression, the ACC is performed through acceleration suppression control. That is, a control signal is generated so as to suppress the acceleration of the vehicle 1 to a certain degree or less. This can be achieved by limiting the instruction amount of the accelerator operation amount, which is provided as the control signal, in the process related to the ACC, for example.

The process to determine whether to perform acceleration suppression will be discussed later. The method of generating a control signal for achieving the ACC is not limited, and is not described herein since the ACC is a related art.

### 3-2. Determination as to Whether ACC Control Processing Section Performs Acceleration Suppression

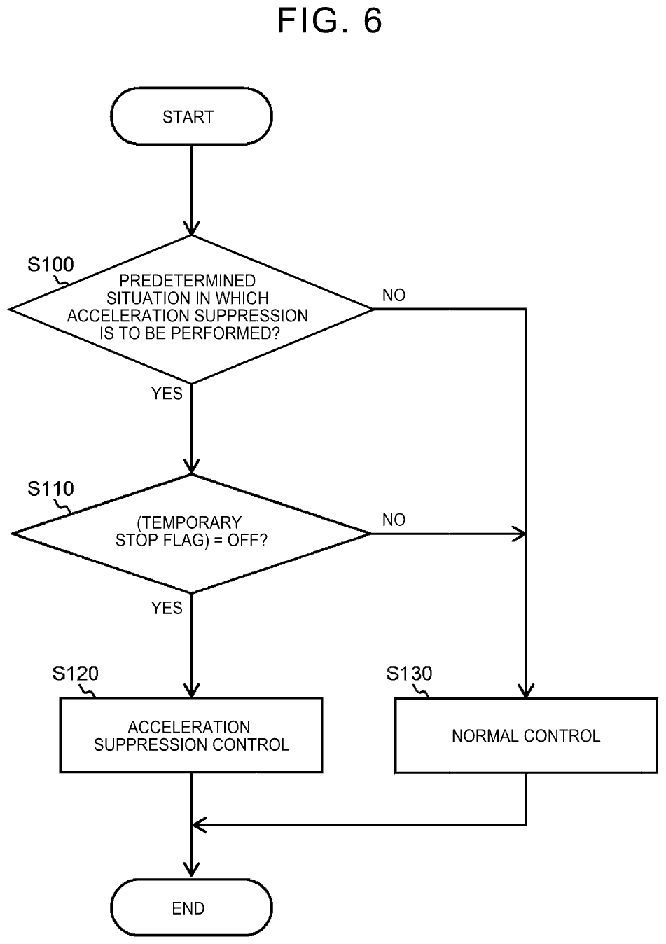

FIG. 6 is a flowchart illustrating a process for the ACC control processing section ACU to determine whether to perform acceleration suppression. The process illustrated in FIG. 6 is executed repeatedly at predetermined intervals.

In step S100, the ACC control processing section ACU determines whether the vehicle is in a predetermined situation in which acceleration suppression is to be performed. This determination is made in accordance with the determination result acquired from the acceleration suppression determination processing section SJU.

When the vehicle is in a predetermined situation in which acceleration suppression is to be performed (step S100: Yes), the process proceeds to step S110. When the vehicle is not in a predetermined situation in which acceleration suppression is to be performed (step S100: No), the process proceeds to step S130. It is determined to perform the ACC through normal control, and the process is ended.

In step S110, the ACC control processing section ACU determines whether the temporary stop flag acquired from the temporary stop determination processing section TSU is turned off.

When the temporary stop flag is turned off (step S110: Yes), the process proceeds to step S120. It is determined to perform the ACC through acceleration suppression control, and the process is ended. When the temporary stop flag is turned on (step S110: No), the process proceeds to step S130. It is determined to perform the ACC through normal control, and the process is ended.

As the process illustrated in FIG. 6 is executed by the ACC control processing section ACU, the ACC is performed through acceleration suppression control or normal control as follows. When the vehicle is not in a predetermined situation in which acceleration suppression is to be performed, the ACC is performed through normal control. When the vehicle is in a predetermined situation in which acceleration suppression is to be performed but the temporary stop flag is turned on, the ACC is performed through normal control (acceleration suppression stop state). When the vehicle is in a predetermined situation in which acceleration suppression is to be performed and the temporary stop flag is turned off, the ACC is performed through acceleration suppression control.

### 3-3. Process Executed by Temporary Stop Determination Processing Section

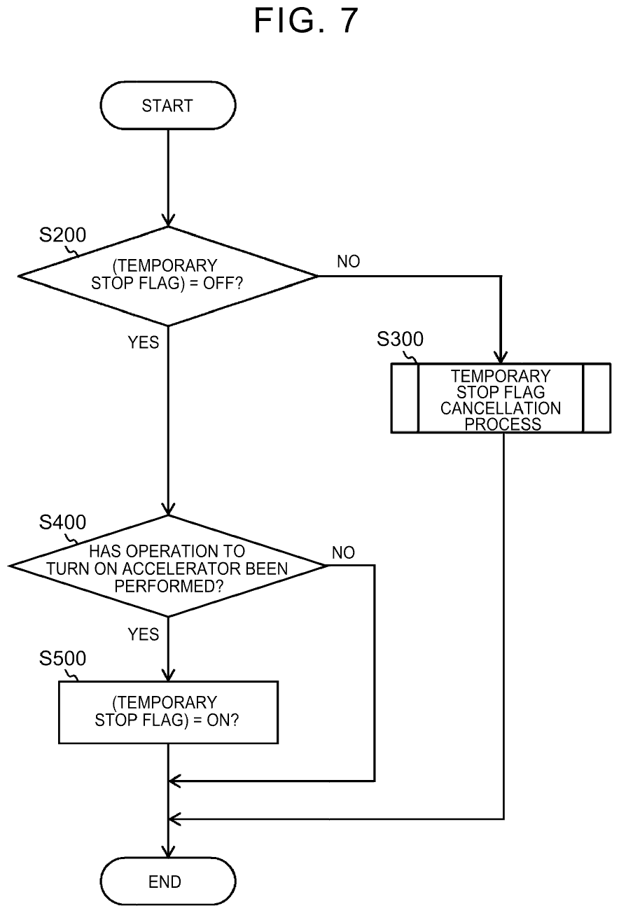

FIG. 7 is a flowchart illustrating a process executed by the temporary stop determination processing section TSU. The process illustrated in FIG. 7 is executed repeatedly at predetermined intervals. In particular, the process illustrated in FIG. 7 may be started when the vehicle is brought into a predetermined situation in which acceleration suppression is to be performed, and performed repeatedly. In this case, it is determined whether the vehicle is in a predetermined situation in which acceleration suppression is to be performed in accordance with the determination result acquired from the acceleration suppression determination processing section SJU. The initial value of the temporary stop flag is off when the process illustrated in FIG. 7 is repeatedly executed.

In step S200, the temporary stop determination processing section TSU determines whether the temporary stop flag is turned off.

When the temporary stop flag is turned off (step S200: Yes), the process proceeds to step S400. When the temporary stop flag is turned on (step S200: No), the process proceeds to step S300. The temporary stop flag cancellation process is executed, and the process is ended. In the temporary stop flag cancellation process, the temporary stop flag is turned off. The process executed in the temporary stop flag cancellation process will be discussed in detail later.

In step S400, the temporary stop determination processing section TSU determines whether an operation to turn on the accelerator has been performed. The determination as to whether an operation to turn on the accelerator has been performed is made by determining that an accelerator operation is in the on state when the accelerator operation amount acquired as the drive environment information is a certain degree or more (e.g. 60% or more), for example. Alternatively, it may be determined that an operation to turn on the accelerator has been performed when the accelerator operation amount is a certain degree or more continuously for a predetermined time or longer.

When an operation to turn on the accelerator has been performed (step S400: Yes), the process proceeds to step S500. The temporary stop flag is turned on, and the process is ended. When an operation to turn on the accelerator has not been performed (step S400: No), the temporary stop flag is kept off, and the process is ended.

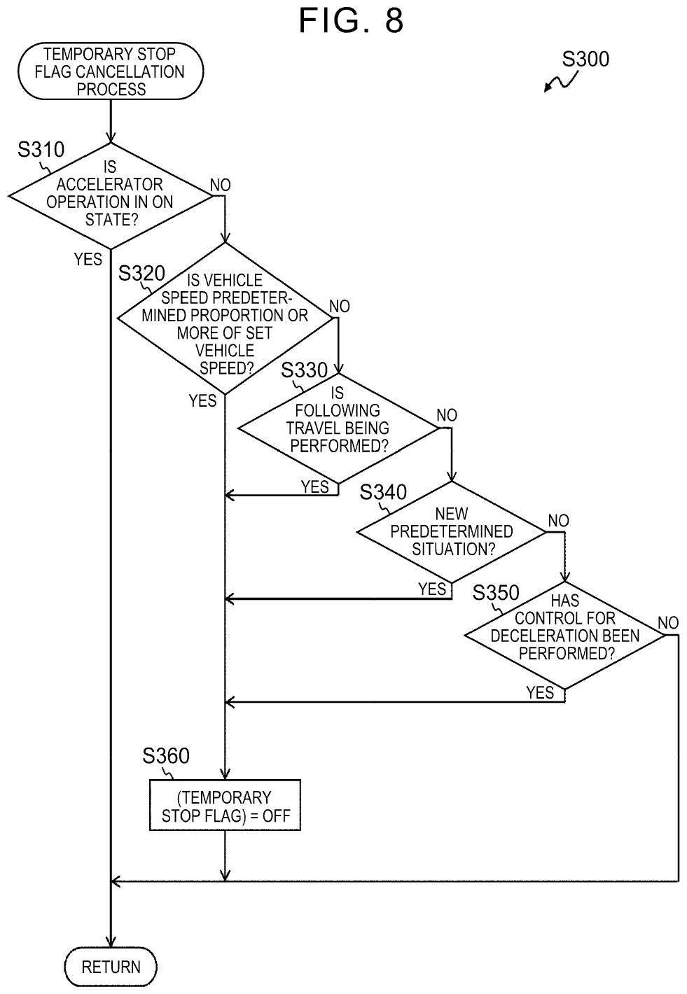

FIG. 8 is a flowchart illustrating a process executed by the temporary stop determination processing section TSU in the temporary stop flag cancellation process (step S300 in FIG. 7).

In step S310, the temporary stop determination processing section TSU determines whether an accelerator operation is in the on state. When an accelerator operation is in the on state (step S310: Yes), the temporary stop flag cancellation process is ended. When an accelerator operation is in the off state (step S310: No), the process proceeds to step S320. This indicates that an operation to turn off the accelerator has just been performed, or that an operation to turn off the accelerator was performed earlier.

In step S320, the temporary stop determination processing section TSU determines whether the vehicle speed of the vehicle 1 is a predetermined proportion or more (e.g. 90% or more) of the set vehicle speed Vs. The predetermined proportion may be a value provided in advance by the control program PG, or may be a value provided in accordance with the set vehicle speed Vs.

When the vehicle speed of the vehicle 1 is a predetermined proportion or more of the set vehicle speed Vs (step S320: Yes), the process proceeds to step S360. The temporary stop flag is turned off, and the temporary stop flag cancellation process is ended. When the vehicle speed of the vehicle 1 is less than the predetermined proportion of the set vehicle speed Vs (step S320: No), the process proceeds to step S330.

In step S330, the temporary stop determination processing section TSU determines whether the following travel is being performed through the ACC.

When the following travel is being performed (step S330: Yes), the process proceeds to step S360. The temporary stop flag is turned off, and the temporary stop flag cancellation process is ended. When the following travel is not being performed (step S330: No), the process proceeds to step S340.

In step S340, the temporary stop determination processing section TSU determines whether the drive environment of the vehicle 1 is brought into a new predetermined situation. The temporary stop determination processing section TSU determines that the drive environment of the vehicle 1 is brought into a new predetermined situation when the drive environment of the vehicle 1 is a predetermined situation different from the situation in which acceleration suppression was determined to be performed, based on the determination result acquired from the acceleration suppression determination processing section SJU, for example. Alternatively, the temporary stop determination processing section TSU determines that the drive environment of the vehicle 1 is brought into a new predetermined situation when the situation in which acceleration suppression was determined to be performed has been resolved and the drive environment of the vehicle 1 is in a predetermined situation again, based on the determination result.

When the drive environment of the vehicle 1 is brought into a new situation in which acceleration suppression is to be performed (step S340: Yes), the process proceeds to step S360. The temporary stop flag is turned off, and the temporary stop flag cancellation process is ended. When the drive environment of the vehicle 1 is not brought into a new situation (step S340: No), the process proceeds to step S350.

In step S350, the temporary stop determination processing section TSU determines whether control for decelerating the vehicle 1 has been performed through the ACC.

When control for decelerating the vehicle 1 has been performed through the ACC (step S350: Yes), the temporary stop flag is turned off, and the temporary stop flag cancellation process is ended. When control for decelerating the vehicle 1 has not been performed (step S350: No), the temporary stop flag cancellation process is ended.

The temporary stop flag is turned off when the result of the determination processes in steps S320 to S350 is positive. That is, the processes define predetermined resumption conditions for resuming acceleration suppression. Thus, in the control device 100 according to the present embodiment, as indicated in steps S320 to S350 in FIG. 8, the predetermined resumption condition is met when any of the following conditions is met. The vehicle speed of the vehicle 1 is a predetermined proportion or more of the set vehicle speed Vs (step S320). The following travel is being performed (step S330). The drive environment of the vehicle 1 is brought into a new predetermined situation (step S340). Control for decelerating the vehicle 1 has been performed through the ACC (step S350).

The order of execution of the determination processes in steps S320 to S350 may be different from that indicated in FIG. 8.

As the processes illustrated in FIGS. 7 and 8 are executed by the temporary stop determination processing section TSU, the acceleration suppression stop state can be continued, even if an operation to turn off the accelerator of the vehicle 1 is performed, until the predetermined resumption condition is met while the acceleration suppression stop state is established when the driver performs an operation to turn on the accelerator. The predetermined resumption condition is as described above.

### 4. Effect

In the control device according to the present embodiment, as described above, acceleration suppression is performed through the ACC when the drive environment of the vehicle 1 is a predetermined situation. The acceleration suppression stop state can be continued, even if an operation to turn off the accelerator is performed, until the predetermined resumption condition is met while the acceleration suppression stop state is established when the driver has performed an operation to turn on the accelerator of the vehicle 1, the driver thereby being considered to have an intention to accelerate. Consequently, it is possible to reduce the possibility that acceleration suppression is performed unnecessarily, and to perform acceleration suppression in the ACC in appropriate situations. Hence, the comfort of the driver can be improved.

Further, the acceleration suppression stop state can be canceled immediately when it is considered to be suitable to perform acceleration suppression again, by determining that the predetermined resumption condition is met when any of the following conditions is met. The vehicle speed of the vehicle 1 is a predetermined proportion or more of the set vehicle speed Vs. The following travel is being performed. The drive environment of the vehicle 1 is brought into a new predetermined situation. Control for decelerating the vehicle 1 has been performed through the ACC.

1. A control device configured to execute control for accelerating or decelerating a vehicle such that constant-speed travel in which the vehicle travels at a set vehicle speed is performed, and configured to execute control for accelerating or decelerating the vehicle such that following travel in which the vehicle follows a preceding vehicle ahead is performed, the control device comprising a processor configured to:
acquire drive environment information that indicates a drive environment of the vehicle;
perform acceleration suppression for suppressing acceleration of the vehicle for the constant-speed travel or the following travel when the drive environment is a predetermined situation;
establish an acceleration suppression stop state in which the acceleration suppression is temporarily stopped when an operation to turn on an accelerator of the vehicle has been performed; and
execute a cancellation process of canceling the acceleration suppression stop state based on a predetermined resumption condition for resuming the acceleration suppression when or after an operation to turn off the accelerator of the vehicle has been performed.

2. The control device according to claim 1, wherein the predetermined resumption condition is met in the cancellation process when one of the following conditions is met:
a vehicle speed of the vehicle is a predetermined proportion or more of the set vehicle speed;
the following travel is being performed;
the drive environment is brought into a new predetermined situation; and
control for decelerating the vehicle is performed for the constant-speed travel or the following travel.

3. A control method for accelerating or decelerating a vehicle such that constant-speed travel in which the vehicle travels at a set vehicle speed is performed, and for accelerating or decelerating the vehicle such that following travel in which the vehicle follows a preceding vehicle ahead is performed, the control method comprising: by a processor,
acquiring drive environment information that indicates a drive environment of the vehicle;
performing acceleration suppression for suppressing acceleration of the vehicle for the constant-speed travel or the following travel when the drive environment is a predetermined situation;
establishing an acceleration suppression stop state in which the acceleration suppression is temporarily stopped when an operation to turn on an accelerator of the vehicle has been performed; and
executing a cancellation process of canceling the acceleration suppression stop state based on a predetermined resumption condition for resuming the acceleration suppression when or after an operation to turn off the accelerator of the vehicle has been performed.

4. The control method according to claim 3 wherein the predetermined resumption condition is met in the cancellation process when one of the following conditions is met:
a vehicle speed of the vehicle is a predetermined proportion or more of the set vehicle speed;
the following travel is being performed;
the drive environment is brought into a new predetermined situation; and
control for decelerating the vehicle is performed for the constant-speed travel or the following travel.

5. A non-transitory storage medium storing instructions that are executable by one or more processors of a computer, and that cause the one or more processors to execute functions comprising:
acquiring drive environment information that indicates a drive environment of a vehicle;
performing acceleration suppression for suppressing acceleration of the vehicle for constant-speed travel or following travel when the drive environment is a predetermined situation;
establishing an acceleration suppression stop state in which the acceleration suppression is temporarily stopped when an operation to turn on an accelerator of the vehicle has been performed; and
executing a cancellation process of canceling the acceleration suppression stop state based on a predetermined resumption condition for resuming the acceleration suppression when or after an operation to turn off the accelerator of the vehicle has been performed.

6. The non-transitory storage medium according to claim 5, wherein the predetermined resumption condition is met in the cancellation process when one of the following conditions is met:
a vehicle speed of the vehicle is a predetermined proportion or more of a set vehicle speed;
the following travel is being performed;
the drive environment is brought into a new predetermined situation; and
control for decelerating the vehicle is performed for the constant-speed travel or the following travel.
